(19) United States
(12) Patent Application Publication
(10) Pub. No.: US 2022/0405770 A1
(43) Pub. Date: Dec. 22, 2022

(54) SYSTEM AND METHODS FOR VERIFYING MERCHANDISE AUTHENTICITY

(71) Applicant: DEEP SIGNATURE LTD., Reading (GB)

(72) Inventors: Jiong Sun, Gilroy, CA (US); Dinh Quan Nguyen, Ho Chi Minh City (VN); Liam James Alford, Reading (GB); Umut Duman, St. Petersburg (RU)

(73) Assignee: DEEP SIGNATURE LTD., Reading (GB)

(21) Appl. No.: 17/513,938

(22) Filed: Oct. 29, 2021

Related U.S. Application Data
(60) Provisional application No. 63/212,634, filed on Jun. 19, 2021.

(51) Int. Cl. G06Q 30/00; H04L 9/32

(52) U.S. Cl. CPC G06Q 30/018; H04L 9/3236; G06Q 2220/00

(57) ABSTRACT

A computer implemented method for verifying merchandise authenticity may include the steps of: receiving a produced instance identification code and a merchandise descriptor for a merchandise instance; generating a first hash output using the produced instance identification code, the merchandise descriptor, and a manufacturer wallet address; storing the first hash output on a blockchain; receiving an acquired instance identification code for the merchandise instance from a client device of a consumer, preferably by scanning a merchandise tag of the merchandise instance with the client device; generating a second hash output using the acquired instance identification code, the merchandise descriptor, and the manufacturer wallet address; generating a third hash output using the acquired instance identification code, the merchandise descriptor, and a consumer wallet address; determining an authenticity output for the merchandise instance; and providing the authenticity output to the client device of the consumer.

### CROSS REFERENCE TO RELATED APPLICATIONS

This application claims priority to and the benefit of the filing date of U.S. Provisional Application No. 63/212,634, filed on Jun. 19, 2021, entitled “Method and apparatus for verifying merchandise authenticity by using blockchain”, which is hereby incorporated by reference in its entirety.

### FIELD OF THE INVENTION

This patent specification relates to the field of systems and methods that enables a customer of a product or merchandise to verify the authenticity of the product, and more particularly to a system and methods that utilize a blockchain and which enables a customer of a product or merchandise to verify the authenticity of the product

### BACKGROUND

Millions of people in the world are cheated into buying counterfeit products every year. The counterfeit merchandise imitates not only luxury items but also pharmaceuticals, food, beverages, software, fashion, electrical & electronics, automotive, etc. The World Health Organization estimated that 10% of medicines in the world, especially in developing countries, could be counterfeit. These illegal activities potentially threaten people's health and even lives, cause economic loss, and damage the reputation of the true manufacturers. Therefore, anti-counterfeit technologies attract intensive interests in R&D and investments. The simplest solution to give an identification to a genuine product without changing its properties is using anti-counterfeit packaging. According to an exclusive report, the global market for anti-counterfeit packaging is expected to reach $188.2 billion by 2025. Another analysis also indicated that the global anti-counterfeiting technologies market size was 51.8 billion USD in 2017, and expected to grow at an average rate of 11.7% from 2018 to 2025.

Conventional anti-counterfeit packaging technologies aim to provide authentic identification to the true products through packaging and sealing. They can be classified into 3 ways in terms of basic working principles as below.

Tracking information: information of the original production, transitional logistic, and distributors of the merchandise must be consistent and confirmable. The information is coded as barcodes or QR codes printed on the packaging and the customers can check the information with mobile apps. This method has a big drawback that the information can be simply copied and reprinted on the counterfeit products. Moreover, online information is stored on centralized system servers, which expose them to the risk of data loss due to technical issues or being interrupted, leading to unauthorized data change or being held to ransom should their servers get compromised.

Authentic identification: by RFID (radio frequency identification), forensic markers (include physical, chemical, and biological taggants), advanced printing like hologram labels or with optical nanoparticles, special fabrication, etc. These methods are expensive and can theoretically be duplicated.

Electronic authentication: a genuine product is enclosed with its unique entity issued by the manufacturer that can be verified through a central database.

These above anti counterfeit packaging technologies are not only expensive, but also require professional suppliers and are highly centralized. The application is thus limited.

In the past few years, it has been widely recognized that blockchain is a revolutionary technology that helps reduce risk, stamps out fraud, and brings transparency in a scalable way for myriad uses. A blockchain system records information in a way that makes it difficult or impossible to change, hack, or cheat the system. Therefore, blockchain is currently the most promising anti-counterfeit technology that soon gets mass adoption in daily life. Indeed, a dozen blockchain anti-counterfeit solutions have been patented in the last ten years. Besides, big companies, such as IBM, JP Morgan, Louis Vuitton, Microsoft, Uniqlo, Vechain, etc., are joining forces to work on product tracking and anti-counterfeit solutions for luxury products based on blockchain technology.

Many possible solutions are proposed using blockchain technology, among which focus on the whole life-cycle tracking of the product. While the solutions are looking promising, they also have some common disadvantages:
Most of them employ specific private or customized blockchains, usually with specifically designed block data structures to store product information. This limits the mass adoption and needs professional knowledge and expert service to apply for the business.
Private or customized blockchains are less secure, due to the limited nodes deployment which are easy to be hacked.
In many cases, the blockchain is dedicated for product tracking only.
The operation protocols are usually complicated, consisting of several steps of processing.
Excessive data is stored on the customized blockchain for other purposes, instead of only for an anti-counterfeiting function.

Therefore, a need exists for novel computer-implemented systems and methods for systems and methods that enables a customer of a product or merchandise to verify the authenticity of the product which do not suffer from the above-mentioned drawbacks of existing systems and methods.

### BRIEF SUMMARY OF THE INVENTION

A system and methods for verifying merchandise authenticity are provided. The system and methods provide a simple and robust anticounterfeit solution which is able to be used on any existing public or private blockchains, using existing block data structure, and does not change any blockchain existing function and transaction (e.g., financial transactions on blockchain). Besides the normal authenticity checking of a product or merchandise instance, this system and methods allows the consumers to check whether the merchandise is brand-new, second hand, etc.

According to one embodiment consistent with the principles of the invention, a computer implemented method for verifying merchandise authenticity is provided. In some embodiments, the method may include the steps of: receiving a produced instance identification code and a merchandise descriptor for a merchandise instance; generating a first hash output using the produced instance identification code, the merchandise descriptor, and a manufacturer wallet address; storing the first hash output on a blockchain; receiving an acquired instance identification code for the merchandise instance from a client device of a consumer, preferably via the client device scanning a merchandise tag of a merchandise instance that the consumer has purchased; generating a second hash output using the acquired instance identification code, the merchandise descriptor, and the manufacturer wallet address; generating a third hash output using the acquired instance identification code, the merchandise descriptor, and a consumer wallet address; determining an authenticity output for the merchandise instance; and providing the authenticity output to the client device of the consumer.

In some embodiments, the authenticity output may describe the merchandise instance as being counterfeit if the first hash output and second hash output do not match.

In some embodiments, the authenticity output may describe the merchandise instance as being authentic if the first hash output and second hash output match and if the third hash output is not already stored on the blockchain.

In some embodiments, the authenticity output may describe the consumer as being the first owner of the merchandise instance if the third hash output is not already stored on the blockchain.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts an illustrative example of some of the components and computer implemented methods which may be found in a system for verifying merchandise authenticity according to various embodiments described herein.

FIG. 2—FIG. 2 illustrates a block diagram showing an example of a server which may be used by the system as described in various embodiments herein.

FIG. 3—FIG. 3 shows a block diagram illustrating an example of a client device which may be used by the system as described in various embodiments herein.

FIG. 4—FIG. 4 depicts a block diagram illustrating some applications of a system for verifying merchandise authenticity which may function as software rules engines according to various embodiments described herein.

FIG. 5—FIG. 5 illustrates a block diagram illustrating an example of a system database according to various embodiments described herein.

FIG. 6—FIG. 6 shows a schematic diagram of an example system for verifying merchandise authenticity according to various embodiments described herein.

FIG. 7—FIG. 7 depicts a block diagram of an example of a computer-implemented method for registering instance identification codes with a system for verifying merchandise authenticity according to various embodiments described herein.

FIG. 8—FIG. 8 illustrates a block diagram of an example of a computer-implemented method which may be used to provide an authenticity output to a consumer using an acquired instance identification code according to various embodiments described herein.

FIG. 9—FIG. 9 shows a block diagram of an example of a computer-implemented method for verifying merchandise authenticity according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the terms “computer” and “computing device” refer to a machine, apparatus, or device that is capable of accepting and performing logic operations from software code. The term “application”, “software”, “software code”, “source code”, “script”, or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software.

The term “electronic device” as used herein is a type of computer comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include: personal computers (PCs), workstations, servers, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, and the like.

The term “client device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of client devices include: personal computers (PCs), workstations, servers, laptops, tablet PCs including the iPad, cell phones including iOS phones made by Apple Inc., Android OS phones, Microsoft OS phones, Blackberry phones, Apple iPads, Anota digital pens, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, tablets, digital pens, wearable computers such as Apple Watch, other smartwatches, Fitbit, other wearable fitness trackers, Google Glasses, and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e., a “wireless network”) which may include WIFI and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigbee network, or a voice-over-IP (VoIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e., information and data from a database may be recorded into a medium on a data store).

As used herein, the term “blockchain” shall generally mean a distributed database that maintains a continuously growing ledger or list of records, called blocks, secured from tampering and revision using hashes. Every time data may be published to a blockchain database the data may be published as a new block. Each block may include a timestamp and a link to a previous block. Through the use of a peer-to-peer network and a distributed timestamping server, a blockchain database is managed autonomously. Blockchains are an open, distributed ledger that can record transactions between two parties efficiently and in a verifiable and permanent way. Consensus ensures that the shared ledgers are exact copies, and lowers the risk of fraudulent transactions, because tampering would have to occur across many places at exactly the same time. Cryptographic hashes, such as the SHA256 computational algorithm, ensure that any alteration to transaction input results in a different hash value being computed, which indicates potentially compromised transaction input. Digital signatures ensure that transactions originated from senders (signed with private keys) and not imposters. This covers different approaches to the processing including hash trees and hash graphs. At its core, a blockchain system records the chronological order of transactions with all nodes agreeing to the validity of transactions using the chosen consensus model. The result is transactions that are irreversible and agreed to by all members in the network.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New computer-implemented systems and methods for verifying merchandise authenticity are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

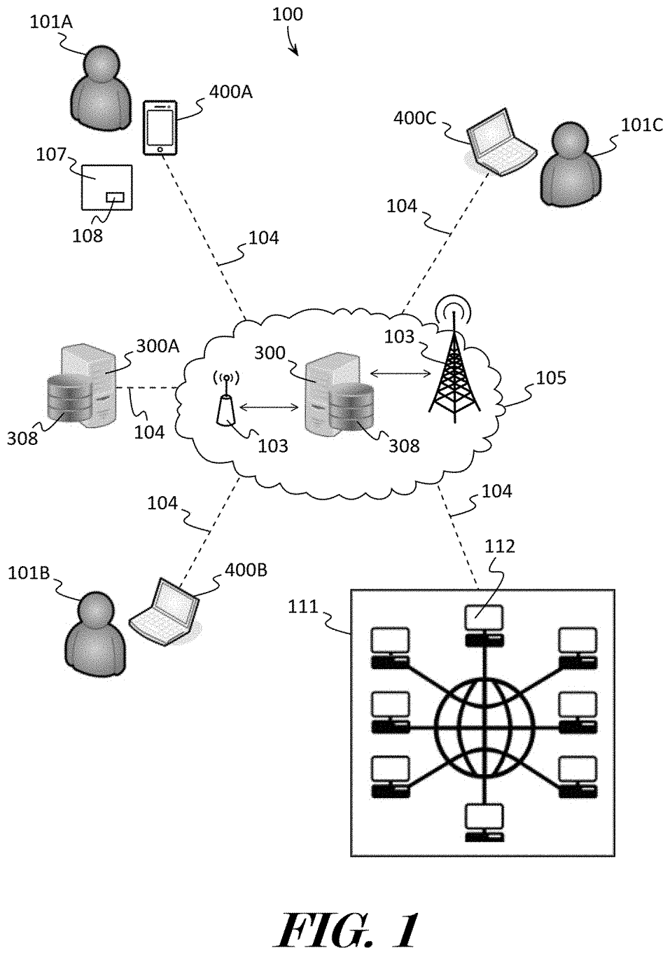

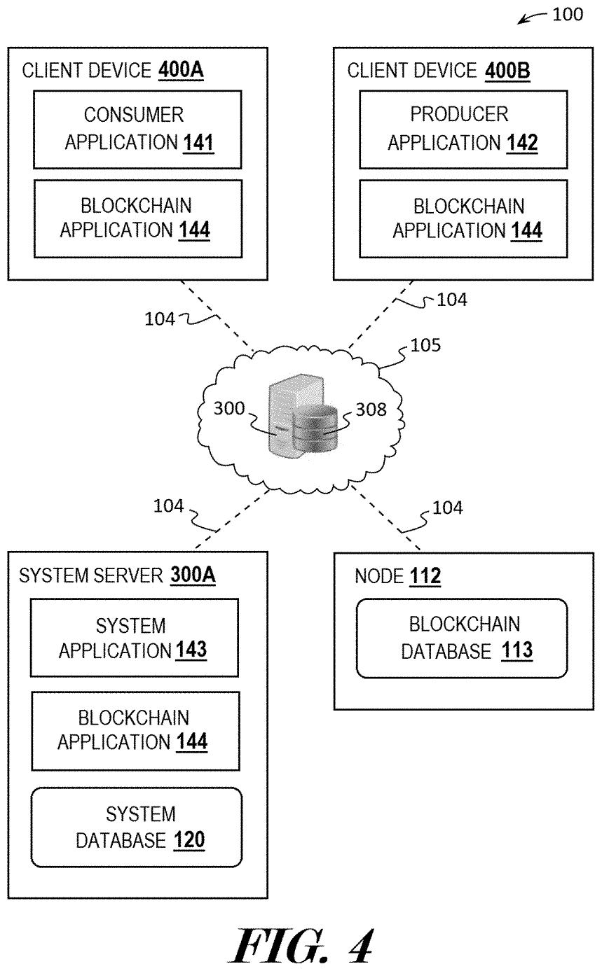

The present invention will now be described by example and through referencing the appended figures representing preferred and alternative embodiments. As perhaps best shown by FIG. 1, an illustrative example of some of the physical components which may comprise a system for verifying merchandise authenticity (“the system”) 100 according to some embodiments is presented. The system 100 is configured to facilitate the transfer of data and information between one or more access points 103, client devices 400, and servers 300 over a data network 105. Each client device 400 may send data to and receive data from the data network 105 through a network connection 104 with an access point 103. The system 100 may comprise one or more system servers 300A that may have a data store 308 that may contain one or more system databases 120 (FIGS. 4-6). Servers 300 may enable network communication between on or more system servers 300A and client devices 400 of the system 100, while system servers 300A may perform one or more functions of the system 100. A system database 120 may have data that may comprise any information which may enable the system 100 to verify the authenticity of merchandise including: information on or describing one or more users 101, information on or describing one or more merchandise instances 107, information on or describing one or more consumers 101A, information on or describing producers 101B, information describing one or more hash outputs, information requested by one or more users 101, information supplied by one or more users 101, and any other information which may be generated by or utilized by the system 100.

In this example, the system 100 comprises at least one client device 400 (but preferably more than two client devices 400) configured to be operated by one or more users 101. Client devices 400 can be mobile devices, such as laptops, tablet computers, personal digital assistants, smart phones, and the like, that are equipped with a wireless network interface capable of sending data to one or more servers 300 with access to one or more data stores 308 over a network 105 such as a wireless local area network (WLAN). Additionally, client devices 400 can be fixed devices, such as desktops, workstations, and the like, that are equipped with a wireless or wired network interface capable of sending data to one or more servers 300 with access to one or more data stores 308 over a wireless or wired local area network 105. The present invention may be implemented on at least one client device 400 and/or system server 300A programmed to perform one or more of the steps described herein. In some embodiments, more than one client device 400 and/or system server 300A may be used, with each being programmed to carry out one or more steps of a method or process described herein.

In some embodiments, the system 100 may be configured to facilitate the communication of information to and from one or more users 101, through their respective client devices 400, using one or more servers 300/300A. Users 101 of the system 100 may include one or more consumers 101A, producers 101B, and service providers 101C. Typically, consumers 101A are individuals or entities that purchase and use merchandise or products, producers 101B are individuals or entities that manufacture merchandise or products, and service providers 101C are individuals or entities that provide the software for producers 101B and customers 101A and perform other system 100 maintenance and management functions. For example, a service provider 101C may keep a system database 120 (FIGS. 4-6) for valid producers 101B, products or merchandise, and wallet addresses, on a server 300 cluster on the backend to serve requests and deals the communications with blockchain network 111, etc.

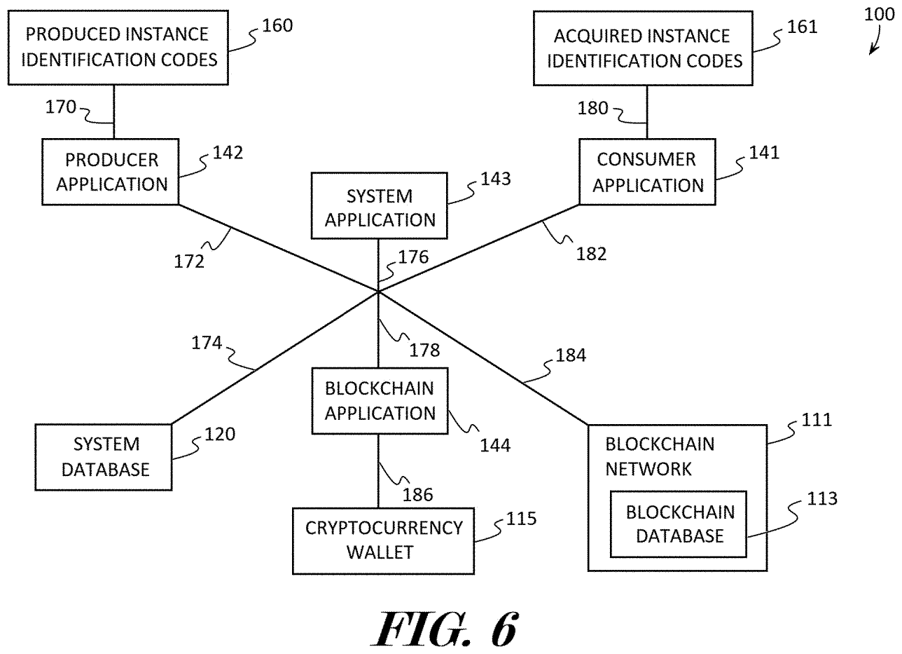

Generally, the system 100 may be used to verify merchandise or product authenticity. Merchandise may comprise: physical goods, such as designer handbags, watches, books, jewelry, food items, artwork, collectables, tickets, etc.; non-physical goods, such as software, digital recordings, images, virtual property, virtual items, etc.; services, such as which may be performed by an individual or entity; or any other item which may be bought and sold. A single unit of merchandise is referred to herein as a “merchandise instance” 107. For example, each merchandise instance 107 (particular unit or instance of merchandise) may have a unique serial number. Producers 101B will first register with the system 100 and provide information on one or more merchandise instances 107 that they desire to be capable of having its authenticity verified. Once registered, producers 101B will be able to register an instance identification code for each merchandise instance 107, such as which may be encoded in a merchandise tag 108. A merchandise tag 108 may comprise a barcode, Quick Response (QR) code, Near-field communication (NFC) tag, Radio Frequency Identification (RFID) tag, etc., that may encode an instance identification code unique to a merchandise instance 107. Each merchandise instance manufactured by a producer 101B may have a merchandise tag 108 attached to it, attached to its packaging, or otherwise coupled together. Each instance identification code may be entered into a system database 120, by using a producer application 142 (FIGS. 4 and 6), as an instance identification code 123. Consumers 101A, preferably once having purchased a merchandise instance 107, will be able to use a consumer application 141 (FIGS. 4 and 6) to verify the authenticity of the merchandise instance 107 using system 100 generated hash outputs that may be stored in a blockchain database 113 (FIGS. 4 and 6). In some embodiments, the system 100 may verify the authenticity of a merchandise instance 107 by outputting information to the consumer 101A that bought the merchandise instance 107 that describes the merchandise instance 107 as being authentic, being counterfeit (not authentic), or as being authentic but that the consumer 101A is not the first owner of the merchandise instance 107 (the merchandise instance is secondhand 107).

In some embodiments, the system 100 may include or be in communication with a blockchain network 111, having one or more nodes 112, which may be in communication with one or more apparatuses 101, system servers 300A, and/or client devices 400 of the system 100. A node 112 may be a server 300, an apparatus 101, a client device 400, or any other suitable networked computing platform. The blockchain network 111 may manage a distributed blockchain database 113 containing data recorded by the one or more apparatuses 101 of the system 100. The data recorded by the one or more apparatuses 101 may be maintained as a continuously growing ledger or listing of the data recorded by the one or more apparatuses 101, which may be referred to as blocks, secured from tampering and revision. Each block includes a timestamp and a link to a previous block. Through the use of a peer-to-peer blockchain network 111 and a distributed timestamping server 300, a blockchain database 113 may be managed autonomously. Consensus ensures that the shared ledgers are exact copies, and lowers the risk of fraudulent transactions, because tampering would have to occur across many places at exactly the same time. Cryptographic hashes, such as the SHA-256 computational algorithm, ensure that any alteration to transaction data input results in a different hash value being computed, which indicates potentially compromised transaction input. Digital signatures ensure that data entry transactions (data added to the blockchain database 113) originated from senders (signed with private keys) and not imposters. At its core, a blockchain database 113 may record the chronological order of data entry transactions with all nodes 112 agreeing to the validity of entry transactions using the chosen consensus model. The result is data entry transactions that are irreversible and agreed to by all members in the blockchain network 111.

The blockchain network 111 may comprise a cryptocurrency or digital asset designed to work as a medium of exchange that uses cryptography to secure its transactions, to control the creation of additional units, and to verify the transfer of assets. Example cryptocurrencies include Bitcoin, Ether, Ripple, etc. The blockchain network 111 may also comprise tokens common to cryptocurrency based blockchain networks 111. The tokens may serve as a reward or incentive to nodes 112 for blockchain network 111 services and to make the blockchain network 111 attach resistant. The blockchain network 111 may comprise token governance rulesets based on crypto economic incentive mechanisms that determine under which circumstances blockchain network 111 transactions are validated and new blocks are created. Tokens may include usage tokens, utility token, work tokens, behavioral tokens, Intrinsic, Native or Built-in tokens, application token, asset-backed tokens, or any other type of token which may be used in a cryptocurrency network.

The system 100 may utilize one or more public and/or private blockchain networks 111 with enough network nodes 112 that are diversified in different countries and regions can be used by this method. For example, Bitcoin's blockchain is a preferred blockchain network 111 due to its overwhelming security which guarantees the immutability. There are other blockchains (such as DeepOnion) that are periodically linked to Bitcoin and which are also pretty secure. The system 100 is compatible with all existing public blockchain networks 111 that have thousands of nodes 112 around the world, run by different individuals and organizations, thus are very secure when compared to private/customized blockchain networks 111 or centralized database solutions. The benefits of utilizing public established blockchain networks 111 reaches well beyond securing data integrity. Though it is also not limited to, the system 100 is able to register all product items from all companies to a single blockchain network 111. However, should one blockchain network 111 become too congested or expensive to use, the system 100 may easily be migrated to start using another. In preferred embodiments, system 100 may utilize any public or private blockchain network 111 which may record the content of data or file in the blockchain and later verify its authenticity by computing a SHA-256 hash output or other hash output of the data or file. SHA-256 hash of a data or a file is 256-bit long, and it is a “digest” of the data or file, that any small change of the data or file will result in a different hash.

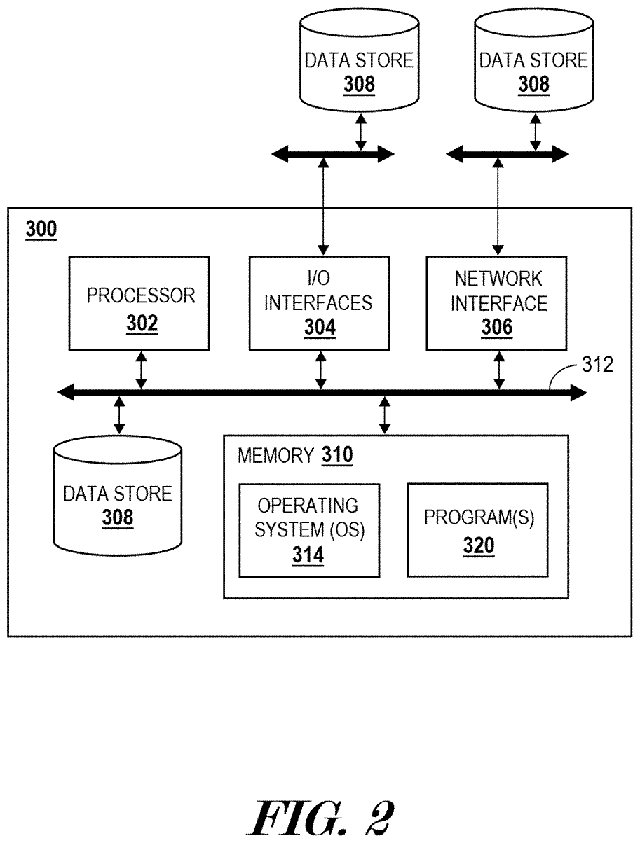

Referring now to FIG. 2, in an exemplary embodiment, a block diagram illustrates a server 300, such as a system server 300A of which one or more may be used in the system 100 or standalone and which may be a type of computing platform. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 2 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data.

The data store 308 is a type of memory and may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally, in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Windows Server 2003/2008/2012/2016 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like.

The one or more programs 320, such as a rules engine 321 (FIG. 4) and an instructional engine 322 (FIG. 4) may be configured to implement the various processes, algorithms, methods, techniques, etc. described herein.

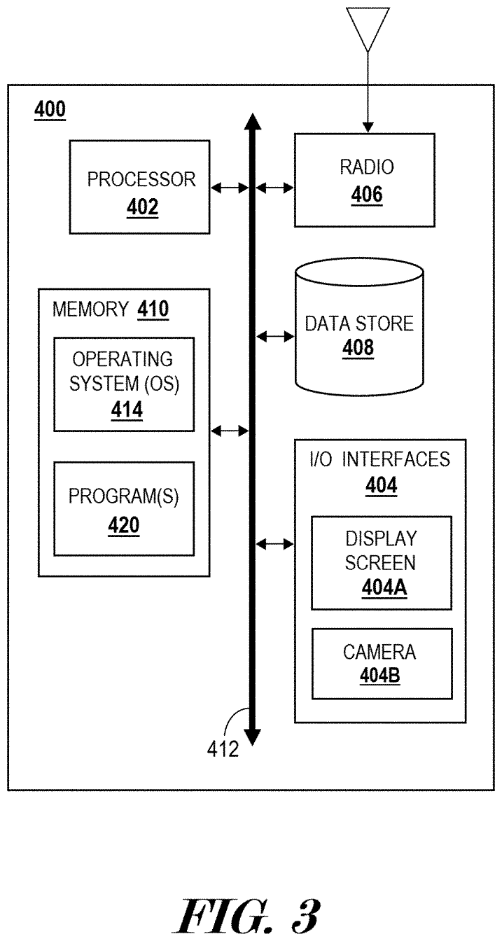

Referring to FIG. 3, in an exemplary embodiment, a block diagram illustrates a client device 400 of which one or more may be used in the system 100 or the like and which may be a type of computing platform. The client device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 3 depicts the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 402 is configured to execute software stored within the memory 410, to communicate data to and from the memory 410, and to generally control operations of the client device 400 pursuant to the software instructions. In an exemplary embodiment, the processor 402 may include a mobile optimized processor such as optimized for power consumption and mobile applications.

The I/O interfaces 404 can be used to receive data and user input and/or for providing system output. User input can be provided via a plurality of I/O interfaces 404, such as a keypad, a touch screen, a camera 404B, a microphone, a scroll ball, a scroll bar, buttons, bar code scanner, voice recognition, eye gesture, and the like. System output can be provided via a display screen 404A, such as a liquid crystal display (LCD), light emitting diode (LED) display, touch screen display, and the like. The I/O interfaces 404 can also include, for example, a global positioning service (GPS) radio, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the client device 400. Additionally, the I/O interfaces 404 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 408 may be used to store data and is therefore a type of memory. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs 420, each of which includes an ordered listing of executable instructions for implementing logical functions. In the example of FIG. 3, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, Microsoft Windows 10, iOS (available from Apple, Inc.), webOS (available from Hewlett Packard), Blackberry OS (Available from Research in Motion), and the like.

The programs 420 may include various applications, add-ons, etc. configured to provide end user functionality with the client device 400. For example, exemplary programs 420 may include, but not limited to, a web browser, social networking applications, streaming media applications, games, mapping and location applications, electronic mail applications, financial applications, and the like. In a typical example, the end user typically uses one or more of the programs 420 along with a network 105 to manipulate information of the system 100.

Referring now to FIG. 4 a block diagram showing some software rules engines and components which may be found in a system 100 and which may optionally be configured to run on one or more system servers 300A and/or client devices 400 according to various embodiments described herein are illustrated. A system server 300A and client device 400 may be in wired and/or wireless electronic communication through a network 105 with a data store 308. A client device 400 that may be used by a consumer 101A to run a consumer application 141 is referred herein as a consumer client device 400A. A client device 400 that may be used by a producer 101B to run a producer application 142 is referred herein as a producer client device 400B. The engines 141, 142, 143, 144, may be in electronic communication so that data may be readily exchanged between the engines 141, 142, 143, 144, and one or more engines 141, 142, 143, 144, may read, write, or otherwise access data in one or more system databases 120 of one or more data stores 308. Each node 112 of the blockchain network 111 may maintain a blockchain database 113 which may comprise a distributed ledger of the blockchain network 111. One or more of the engines 141, 142, 143, 144, may read, write, or otherwise access data in the blockchain database(s) 113 of or associated with the system 100.

In some embodiments, the system 100 may comprise one or more system servers 300A that may be configured to run one or more software rules engines or programs, such as a system application 143 and a blockchain application 144, while a consumer client device 400A may be configured to run one or more software rules engines or programs, such as a consumer application 141 and, optionally, a blockchain application 144, and a producer client device 400B may be configured to run one or more software rules engines or programs, such as a producer application 142 and, optionally, a blockchain application 144.

In some embodiments, a producer client device 400B may run a blockchain application 144 which enables the producer client device 400B to interact with blockchain network 111 and/or database 113 directly. In further embodiments, a producer application 142 running on a producer client device 400B may communicate with a blockchain application 144 running on a system server 300A which enables the producer client device 400B to interact with blockchain network 111 and/or database 113 via the blockchain application 144. Likewise, and in some embodiments, a consumer client device 400A may run a blockchain application 144 which enables the consumer client device 400A to interact with blockchain network 111 and/or database 113 directly. In further embodiments, a consumer application 141 running on the consumer client device 400A may communicate with a blockchain application 144 running on a system server 300A which enables the consumer client device 400A to interact with blockchain network 111 and/or database 113 via the blockchain application 144.

In other embodiments, a consumer application 141, producer application 142, system application 143, and/or blockchain application 144 may be configured to run on one or more client devices 400 and/or system servers 300A with data transferred engines 141, 142, 143, 144, through a network 105. It should be understood that the functions attributed to the engines 141, 142, 143, 144, described herein are exemplary in nature, and that in alternative embodiments, any function attributed to any engine 141, 142, 143, 144, may be performed by one or more other engines 141, 142, 143, 144, or any other suitable processor logic.

The system 100 may comprise one or more databases, such as a system database 120, which may be stored on a data store 308 accessible to one or more engines 141, 142, 143, 144. In some embodiments, a system database 120 may comprise information comprise any information which may enable the system 100 to verify the authenticity of merchandise instances 107 including: information on or describing one or more users 101, information on or describing one or more merchandise instances 107, information on or describing one or more consumers 101A, information on or describing producers 101B, information describing one or more hash outputs, information describing one or more product codes, information requested by one or more users 101, information supplied by one or more users 101, and any other information which may be generated by or utilized by the system 100.

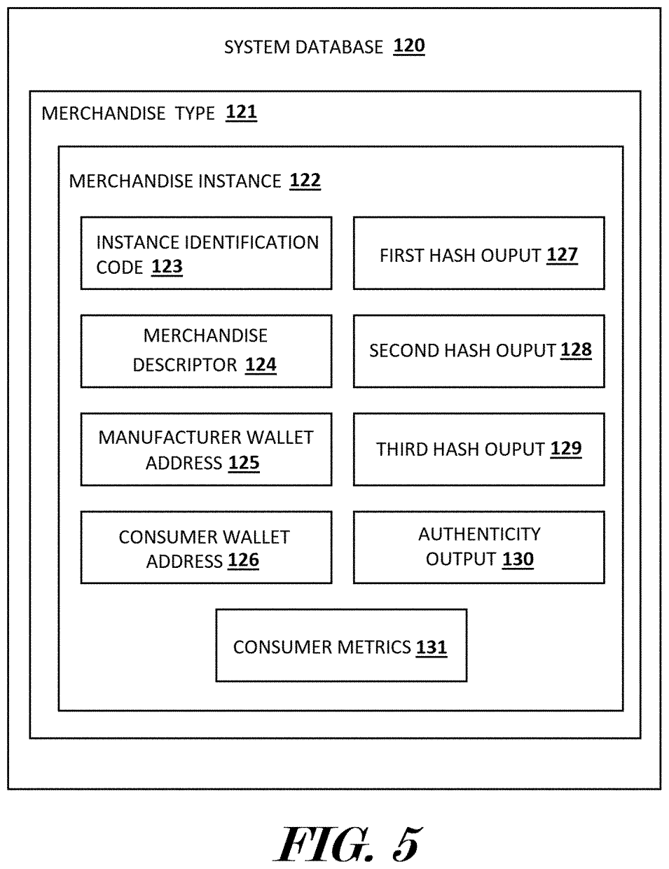

FIG. 5 provides an example structure of a system database 120. It should be understood that the described structure of the system database 120 is exemplary in nature, and that in alternative embodiments, the data contained within the system database 120 may be organized in any other way.

In some embodiments, a system database 120 may comprise a merchandise type 121 data record for each merchandise type or product type for which the system 100 may be used to verify the authenticity of Generally, a merchandise type 121 data record may comprise a merchandise instance 122 data record for each merchandise instance 107 (instance or unit of merchandise) that a producer 101B wishes to enter into the system 100, and a merchandise instance 122 data record may comprise data for a particular merchandise instance 107. For example, a merchandise type 121 data record may comprise a specific model of luxury watch (the producer 101B being the manufacturer of the watch) and the merchandise type 121 data record may comprise a merchandise instance 122 data record for each merchandise instance 107 of the model of luxury watch. In this example, each particular watch would be a merchandise instance 107 and would have its own serial number. A merchandise type 121 data record may be used to group one or more, such as a plurality of merchandise instance 122 data records together in the system database 120.

In some embodiments, each merchandise instance 122 data record may comprise one or more of an instance identification code 123, a merchandise descriptor 124, a manufacturer wallet address 125, a consumer wallet address 126, a first hash output 127, a second hash output 128, a third hash output 129, and an authenticity output 130.

An instance identification code 123 data record may comprise an alphanumeric string which may be unique to a specific merchandise instance. For example, an instance identification code 123 data record may comprise a serial number of the merchandise instance 107 described by a particular merchandise instance 122 data record. Each merchandise tag 108 used by the system 100 may encode the data in an instance identification code 123 data record. In preferred embodiments, each registered merchandise instance 107 may comprise a seal which may be created or formed by the manufacturer 101B prior to the merchandise instance 107 leaving the manufacturer 101B and which may prevent access to the merchandise tag 108 and its instance identification code of a respective merchandise instance 107. For example, a registered merchandise instance 107 may comprise a shrink wrap or bubble packaging seal which may prevent the reading of the instance identification code of its merchandise tag 108 by a consumer client device 400A until the seal is broken.

A merchandise descriptor 124 data record may comprise information that describes the merchandise instance 107 described by a particular merchandise instance 122 data record. This may include manufacturer or producer 101B name, model number or name, series number, color scheme, or any other information that may describe a merchandise instance 107.

A manufacturer wallet address 125 data record may comprise information describing or identifying a cryptocurrency address that is associated with the producer 101B or manufacturer of merchandise instances 107.

A consumer wallet address 126 data record may comprise may comprise information describing or identifying a cryptocurrency address that is associated one or more third hash outputs that are generated by the system 100 and which are stored in a blockchain database 113.

A first hash output 127 data record may comprise the output of a hash function that may be performed using the instance identification code 123, merchandise descriptor 124, and manufacturer wallet address 125 data records of a merchandise instance 122 data record. The first hash output 127 data record may be stored in a blockchain database 113 of a blockchain network 111 and optionally in the system database 120. Any suitable hash function may be used to generate the first hash output 127, such as MD5 (MD5CryptoServiceProvider with hash length of 128 bits, SHA-1 with hash length of 160 bits, SHA-256 with hash length of 256 bits, SHA-384 with hash length of 384 bits, SHA-512 with hash length of 512 bits, etc. In preferred embodiments, the first hash output 127 may be generated using a hash function that provides at least a 128 bit output. In further preferred embodiments, the first hash output 127 may be generated using a SHA-256 hash function.

A second hash output 128 data record may comprise the output of a hash function that may be performed using the instance identification code 123, merchandise descriptor 124, and manufacturer wallet address 125 data records of a merchandise instance 122 data record using an instance identification code stored in a merchandise tag 108 received from a consumer client device 400A. The second hash output 128 data record may be stored in a blockchain database 113 of a blockchain network 111 and optionally in the system database 120. Any suitable hash function may be used to generate the second hash output 128. In preferred embodiments, the second hash output 128 may be generated using a hash function that provides at least a 128 bit output. In further preferred embodiments, the second hash output 128 may be generated using a SHA-256 hash function.

A third hash output 129 data record may comprise the output of a hash function that may be performed using the instance identification code 123, merchandise descriptor 124, and consumer wallet address 126 data records of a merchandise instance 122 data record. In preferred embodiments, a third hash output 129 data record may comprise a third hash output for each owner of a merchandise instance having a merchandise instance 122 data record. The third hash output 129 data record may be stored in a blockchain database 113 of a blockchain network 111 and optionally in the system database 120. Any suitable hash function may be used to generate a third hash output 129. In preferred embodiments, a third hash output 129 may be generated using a hash function that provides at least a 128 bit output. In further preferred embodiments, a third hash output 129 may be generated using a SHA-256 hash function.

An authenticity output 130 data record may comprise information describing the authenticity output of a merchandise instance 107 that the system 100 may provide to a consumer 101A that has entered in an instance identification code 123 of the merchandise instance, preferably by scanning a merchandise tag 108 of the merchandise instance 107. Optionally, an authenticity output 130 data record may be generated for each consumer 101A and may describe each authenticity output generated for that consumer 101A, such that an authenticity output 130 data record may be stored separately from the merchandise instance 122 data records. In some embodiments, the system 100 may verify the authenticity of a merchandise instance 107 by generating authenticity output that includes one or more of: the merchandise instance 107 is authentic, is counterfeit (not authentic), or is authentic but that the consumer 101A querying the system 100 about the merchandise instance 107 is not the first owner of the merchandise instance 107 (the merchandise instance 107 is secondhand, thirdhand, etc.).

A consumer metrics 131 data record may comprise information describing analytic data describing a sale progression of the merchandise instance 107 of the merchandise instance 122 data record. Preferably, information of a consumer metrics 131 data record may comprise information about the first ownership of the merchandise instance, such as a time stamp (such as which may describe the time and date that a third hash 129 was generated, which may describe the time and date that a third hash 129 was stored in the blockchain 113, etc.) of one or more third hash functions, which can provide valuable information about the sale progression of the merchandise type/merchandise instance, and this information together with other analytics may be provided to one or more producers 101B to provide manufacturer insights on the timing and popularity of their product among consumers 101A. As an example, if a third hash output for a merchandise instance 107 is not found in the blockchain 113 (and the first and second hash outputs match), an authenticity output 130 may describe that the merchandise instance 107 is authentic and brand-new, and the third hash output is registered in the blockchain 113. The next time the merchandise tag 108 is scanned the authenticity output 130 will describe that the merchandise instance 107 is no longer brand-new. By scanning the time stamp when third hash output is registered in the blockchain 113, the time stamp generally describes the time the merchandise instance 107 was sold. By scanning a plurality of merchandise instances 107, such as all merchandise instances 107, of certain product, the consumer metrics 131 data records may be used to generate information describing the sale progression of a product to which the merchandise instances 107 belong.

The system 100 may comprise one or more consumer applications 141. A consumer application 141 may comprise or function as consumer logic stored in a memory 410, which may be executable by the processor 402 of a consumer client device 400A. Optionally, a consumer application 141 may be executable by the processor 302 of a system server 300A. In some embodiments, a consumer application 141 may generate a user interface, such as a graphical user interface, on the client device 400A of a consumer 101A which may enable the consumer 101A to provide system 100 input and receive system 100 output. In some embodiments, a consumer application 141 may be configured to operate or receive information from an I/O interface 404 of a consumer client device 400A which allows a merchandise tag 108 to be read by the I/O interface 404. For example, a camera 404B I/O interface 404 may read a merchandise tag 108 that comprises a bar code, QR code, or other optically readable code on a product. As another example, a radio 406 may read a merchandise tag 108 comprising an RFID tag, an NFC tag, or other wirelessly/wiredly readable code on a product instance 107. A consumer application 141 may also perform one or more other functions as described herein.

The system 100 may comprise one or more producer applications 142. A producer application 142 may comprise or function as producer logic stored in a memory 410, which may be executable by the processor 402 of a producer client device 400B. Optionally, a producer application 142 may be executable by the processor 302 of a system server 300A. In some embodiments, a producer application 142 may generate a user interface, such as a graphical user interface, on the client device 400B of a producer 101B which may enable the producer 101B to provide system 100 input and receive system 100 output. In some embodiments, a producer application 142 may be configured to operate or receive information from an I/O interface 404 of a producer client device 400B which allows a merchandise tag 108 to be read by the I/O interface 404. For example, a camera 404B I/O interface 404 may read a merchandise tag 108 that comprises a bar code, QR code, or other optically readable code on a product. As another example, a radio 406 may read a merchandise tag 108 comprising an RFD tag, an NFC tag, or other wirelessly/wiredly readable code on a product. In some embodiments, a producer application 142 may enable a producer 101B to upload one or more instance identification codes of one or more merchandise tags 108 to the system 100. A producer application 142 may also perform one or more other functions as described herein.

The system 100 may comprise one or more system applications 143. A system application 143 may comprise or function as system logic stored in a memory 410, which may be executable by the processor 302 of a system server 300A. Optionally, a system application 143 may be executable by a processor 402 of a client device 400. In some embodiments, a system application 143 may generate a user interface, such as a graphical user interface, on a client device 400 of a service provider 101C which may enable the service provider 101C to provide system 100 input and receive system 100 output. In some embodiments, a system application 143 may generate a user interface, such as a graphical user interface, on a client device 400 of a consumer 101A which may enable the consumer 101A to provide system 100 input and receive system 100 output. In some embodiments, a system application 143 may generate a user interface, such as a graphical user interface, on a client device 400 of a producer 101B which may enable the producer 101B to provide system 100 input and receive system 100 output. Both producer applications 142 and consumer applications 141 may be generated and released by a system application 143. A system application 143 may also perform one or more other functions as described herein.

The system 100 may comprise one or more blockchain applications 144. A blockchain application 144 may comprise or function as blockchain logic stored in a memory 310, 410, which may be executable by the processor 302, 402, of a system server 300A and/or a client device 400. In some embodiments, a blockchain application 144 may perform interactions and transactions with a blockchain network 111 and generate one or more hash outputs which may be stored in a blockchain database 113. In further embodiments, a blockchain application 144 may generate, manage, create, or perform other functions relating to one or more cryptocurrency wallets 115 and their addresses. A blockchain application 144 may also perform one or more other functions as described herein.

FIG. 6 is a schematic diagram of an example system 100 according to various embodiments described herein. The system 100 may comprise or may be in communication with one or more blockchain networks 111, one or more producer applications 142, one or more consumer applications 141, one or more system applications 143, one or more blockchains applications 144, one or more system database 120, and one or more cryptocurrency wallets 115. Communications links 170, 172, 174, 176, 178, 180, 182, 184, 186, which allow data exchange, may be implemented by any medium or mechanism that provides data exchanges between the two components. Examples of communications links include, without limitation, remote procedure call (RPC), secure shell (SSH), and secure hypertext transfer protocol (HTTPS). As an example, communication links 172, 176, in the example embodiment in FIG. 6, between producer application 142 and system application 143, may be realized using HTTPS protocol.

For each merchandise instance 107 having a merchandise instance 122 in the system database 120, a system application 143 may assign two different wallet addresses to it. One address may be used by the manufacturer or producer 101B for product registration and consumer verification or authentication of the merchandise instance. Another wallet address is for consumer 101A registration of one or more purchased and verified merchandise instances 107 by one or more consumers 101A. The system 100 may generate one or more hash outputs for product/merchandise instance 107 via blockchain applications 144 of the system 100. For each instance identification code (e.g., encoded in barcode, QR code, etc.), it will be combined with instance identification code 123, merchandise descriptor 124, and a special wallet address that is either for producer 101B (manufacturer wallet address 125) or consumer 101A (consumer wallet address 126) as described above. The instance identification code can be combined with both a producer wallet address and a consumer wallet address. It may either contain both, or none (in which case it may be uploaded from system server 300A). As both addresses are needed by the system 100 for operation. The combined data will then be used by a blockchain application 144 to compute a hash function, such as a SHA-256 hash function, and the hash will be written into the blockchain database 113 in case of registration (first hash output 128), or the hash (second hash output 129) will be searched for in the blockchain database 113 to see if it exists, in case of verification. When written to the blockchain database 113, a special cryptocurrency transaction on the blockchain database 113 may be created. This transaction, containing the hash and address information, is propagated to the blockchain network 111 and the information is thus registered with the blockchain database 113.

For merchandise authenticity identification, a blockchain database 113 is used to store valid and manufactured product code hash data and consumer product registration information. As a blockchain database 113 is an immutable database, the data once written to the blockchain, can no longer be tampered with or altered. Producers 101B of a merchandise instance and consumers 101A who purchase the merchandise instance associated with a merchandise instance 122 data record, can register or verify the authenticity of the data with the blockchain database 113 via a blockchain application 144 that interfaces with the blockchain network 111. Optionally, the system 100 may comprise a cluster of backend or system servers 300A which may run one or more blockchain applications 144 to enable the interaction of one or more consumer client devices 400A and producer client devices 400B with a blockchain database 113. The applications 141, 142, 143, optionally may either interact with a blockchain application 144 run on a cluster of backend or system servers 300A, which in turn communicate with the blockchain network 111, or one or more consumer client devices 400A and producer client devices 400B can run a blockchain application 144 which may embed a lightweight wallet of the blockchain's 111 cryptocurrency or token, that will interact with the blockchain network 111 directly. The wallet will be able to handle the transactions with the blockchain network 111. Each wallet has a unique address (the cryptocurrency's address, such as a Bitcoin address).

Each merchandise instance 107 registered with the system 100 may comprise an instance identification code, such as which may be encoded in a merchandise tag 108 comprising a barcode, Quick Response (QR) code, Near-field communication (NFC) tag, Radio Frequency Identification (RFID) tag, etc., which may be coupled to or otherwise associated with a respective merchandise instance 107. In preferred embodiments, each registered merchandise instance 107 may comprise a seal which may be created or formed by the manufacturer 101B prior to the merchandise instance 107 leaving the manufacturer 101B and which may prevent access to the merchandise tag 108 and its instance identification code of a respective merchandise instance 107. For example, a registered merchandise instance 107 may comprise a shrink wrap or bubble packaging seal which may prevent the reading of the instance identification code of its merchandise tag 108 by a consumer client device 400A until the seal is broken.

Instance identification codes for merchandise instances 107 produced (produced instance identification codes 160) by producers 101B, may be provided to the system 100 via a producer application 142, such as by being scanned with an I/O interface 404 of a producer client device 400B, being uploaded as a data file, such as spreadsheet, or any other suitable method. The codes may then be transmitted to a system application 143, preferably running on a service provider's system server 300A cluster. Each code will then be processed via a blockchain application 144 and the resulting hash will be sent to blockchain database 113 where it will be recorded as described in the previous section. This process of registering data in blockchain database 113 may also be done with through a corresponding cryptocurrency wallet 115 which is often available for cryptocurrency, should the wallet 115 have the basic functions of registering data with the blockchain database 113 (an example of such cryptocurrency is DeepOnion). Otherwise, a lightweight implementation of the blockchain registering and verifying features may be performed via blockchain application 144. Service-related data and configuration will be stored in system database 120 and is used by the service provider server software (system application 143).

Instance identification code from purchased merchandise instances 107 may be provided to the system 100, preferably by being scanned into a consumer application 141 running on a consumer client device 400A of the purchasing consumers 101A (acquired instance identification codes 161). The codes may then be converted to hash, first with product producer or manufacturer wallet address 125, and then with consumer wallet address 126. Both are checked with blockchain database 113 preferably via a blockchain application 144. The result will determine whether an acquired instance identification code 123 is authentic or not. Invalid result from first hash means the merchandise instance 107 is counterfeit. In case of valid instance identification code 123, the system 100 will further determine that if the consumer 101A is the first one to own the merchandise instance 107. The algorithm may be performed by a system application 143 and/or a blockchain application 144 running on a system server 300A, in which case it is similar to the data path of the producer application 142; or directly on the consumer client device 400A via a blockchain application 144, in which case a lightweight cryptocurrency wallet and registration feature will be implemented in the blockchain application 144.

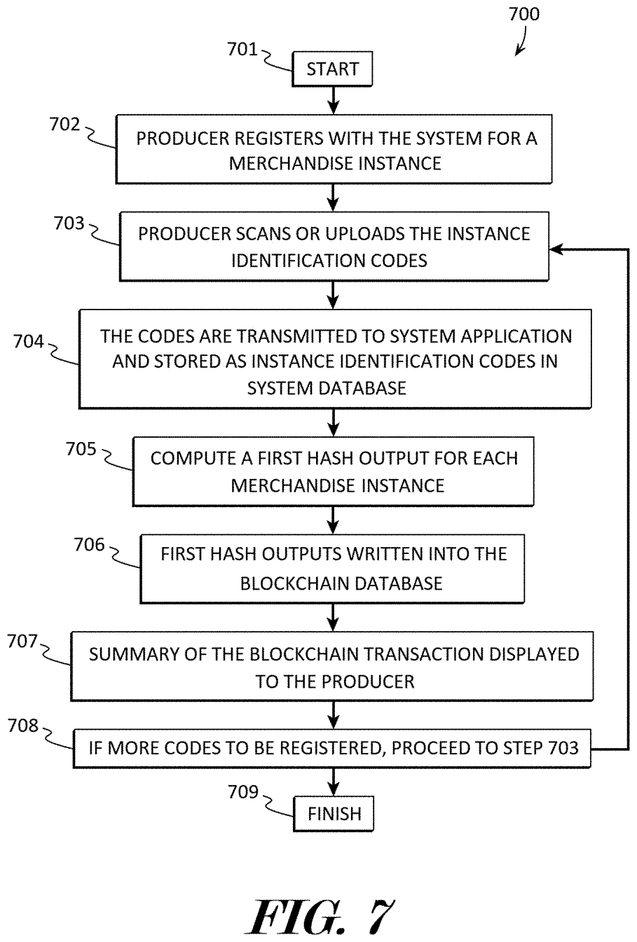

FIG. 7 shows a block diagram of an example of a computer-implemented method for registering instance identification codes with the system (“the method”) 700 according to various embodiments described herein. In some embodiments, the method 700 may be used to enable producers 101B to register instance identification codes with the system 100, in which each instance identification code is associated with a merchandise instance 107 (via its merchandise tag 108 which comprises the instance identification code) as instance an identification code 123 for a merchandise instance 122 in the system database 120. In some embodiments, the producer client device 400B may run a blockchain application 144 which enables the producer client device 400B to interact with blockchain network 111 and/or database 113 directly. In further embodiments, a producer application 142 running on the consumer client device 400A may communicate with a blockchain application 144 running on a system server 300A which enables the consumer client device 400A to interact with blockchain network 111 and/or database 113 via the blockchain application 144. One or more steps of the method 700 may be performed by a producer application 142, system application 143, and/or blockchain application 144 which may be executed by a computing device processor, such as a processor 302 (FIG. 2) and/or a processor 402 (FIG. 3).

In some embodiments, the method 700 may start 701 and in step 702, a producer 101B may register with service provider 101C, and therefore register with the system 100, for the merchandise instance 107 for which the instance identification code will be registered. A blockchain application 144 managed by service provider 101C may create a pair of wallet addresses for producer 101B and the first consumer 101A to register codes in the blockchain database 113 used by the system 100. The wallet addresses may be uploaded to producer application 142 and consumer application 141, so the producer 101B and consumer 101A can register or verify codes directly via a blockchain application 144 running on their respective client devices 400B, 400A. Alternatively, the codes can be kept in a system database 120 on a system server 300A, and all blockchain database 113 interaction may go through a system application 143 and a blockchain application 144 running on a system server 300A.

In step 703, producer 101B may now scan the instance identification code in product line or upload the valid codes in bulk via producer application 142. The bulk code upload can be done with spreadsheet, CSV and other form of files or storage, from any media such as hard drive or CD ROM.

In step 704, the codes are transmitted through secure communications to system application 143 and stored as instance identification codes 123 in system database 120. In some embodiments, the codes may be transmitted through secure communications to system application 143 running on one or more system servers 300A and stored as instance identification codes 123 in system database 120. In further embodiments, a blockchain application 144 running on the producer's client device 400B may communicate the codes directly with blockchain 113 without going through a system application 143 and system server 300A.

In step 705, a blockchain application 144 will use each instance identification code 123 received from the producer 101B, combining instance identification code 123, merchandise descriptor 124, and manufacturer wallet address 125, and compute a first hash output for each merchandise instance 122.

In step 706, this first hash output may be written into the blockchain database 113 via blockchain application 144. In some embodiments, a cryptocurrency transaction is created in step 706, with the first hash output included, and is sent to the blockchain network 111.

The blockchain application 144 handles the return information from the blockchain network 111 in step 707, and a summary of the transaction may be displayed to the producer 101B via producer application 142.

Finally, in step 708, if the producer 101B has more codes to register, they may proceed back to step 703 and repeat steps 703-708. After step 708, the method 700 may finish 709.

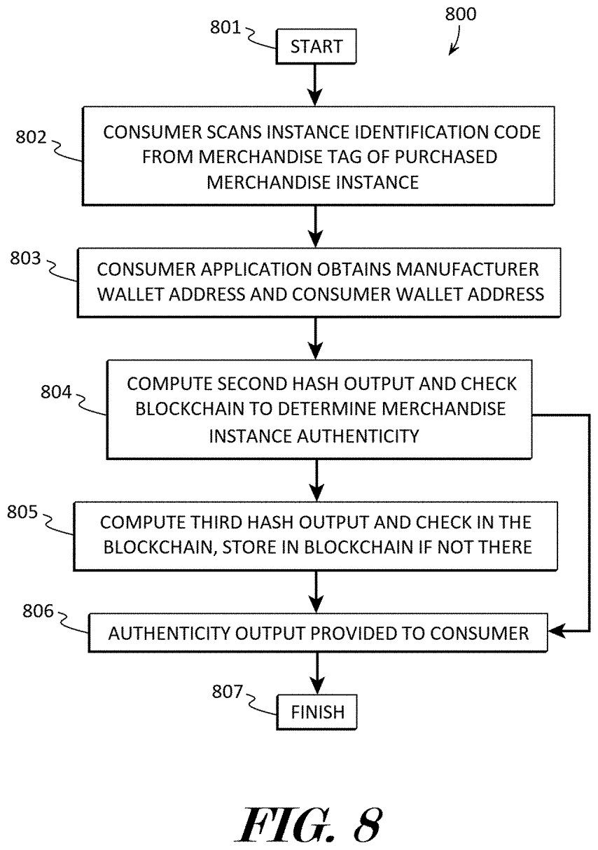

FIG. 8 depicts a block diagram of an example of a computer-implemented method which may be used to provide authenticity output to a consumer (“the method”) 800 according to various embodiments described herein. In some embodiments, the method 800 may be used to enable a consumer 101A, in an embodiment, to verify the authenticity of a purchased merchandise instance 107 using their client device 400A. In some embodiments, the consumer client device 400A may run a blockchain application 144 which enables the consumer client device 400A to interact with blockchain network 111 and/or database 113 directly. In further embodiments, a consumer application 141 running on the consumer client device 400A may communicate with a blockchain application 144 running on a system server 300A which enables the consumer client device 400A to interact with blockchain network 111 and/or database 113 via the blockchain application 144. One or more steps of the method 800 may be performed by a consumer application 141, system application 143, and/or blockchain application 144 which may be executed by a computing device processor, such as a processor 302 (FIG. 2) and/or a processor 402 (FIG. 3).

In some embodiments, the method 800 may start 801 and in step 802 a consumer 101A may utilize a consumer application 141 running on their client device 400A to scan an instance identification code (acquired instance identification code 161) from a merchandise tag 108 of a merchandise instance 107 they have purchased via an I/O interface 404 of their electronic device 400A.

In step 803, the consumer application 141 may obtain manufacturer wallet address 125 and consumer wallet address 126. Optionally, the consumer application 141 may obtain the merchandise descriptor 124 of the merchandise instance 122 identified by the instance identification code 123 from the system database 120, from consumer 101A input to the consumer application 141, and/or from the merchandise tag 108. In some embodiments, the consumer application 141 may upload metadata from system database 120, optionally via a system application 143, if they are not there. For example, the metadata related to a special merchandise instance 107 or product the consumer 101A wants to authenticate.

In step 804, a blockchain application 144, optionally running on the consumer client device 400A or on a system server 300A may compute a second hash output, by combining the instance identification code 123 with manufacturer and product identifiers (merchandise descriptor 124), and producer manufacturer wallet address 125. The second hash output is checked with the blockchain database 113 to ascertain whether it already exists in a previous transaction. If it does not exist, then the product or purchased merchandise instance 107 is determined to be counterfeit (which is used to generate data in an authenticity output 130), as all valid product code hashes are already registered in the blockchain database 113 by the manufacturer or producer 101B. If the purchased merchandise instance 107 is determined to be counterfeit in step 804, the method 800 may proceed to step 806. If the purchased merchandise instance 107 is not determined to be counterfeit in step 804, the method 800 may proceed to step 805.

In step 805, a third hash output is computed by combining the instance identification code 123 with manufacturer and product identifiers (merchandise descriptor 124), and consumer wallet address 126. It the third hash output may be first checked with the blockchain database 113 to ascertain whether it already exists in the in a previous transaction. If the hash already exists, then the purchased merchandise 107 instance is either second-hand, or it is a counterfeit one. If not, then it is certain that the purchased merchandise instance 107 is authentic and is brand-new. In the latter case a cryptocurrency transaction will be generated which includes the third hash output, and is sent to blockchain network 111 to register and be stored in blockchain database 113.

In step 806, an authenticity output 130 is generated which may comprise a report on the purchased merchandise instance 107 authenticity and may be provided, such as by being displayed to the consumer 101A on their client device 400A via the consumer application 141, based on the results from the previous steps. After step 806, the method may finish 807.

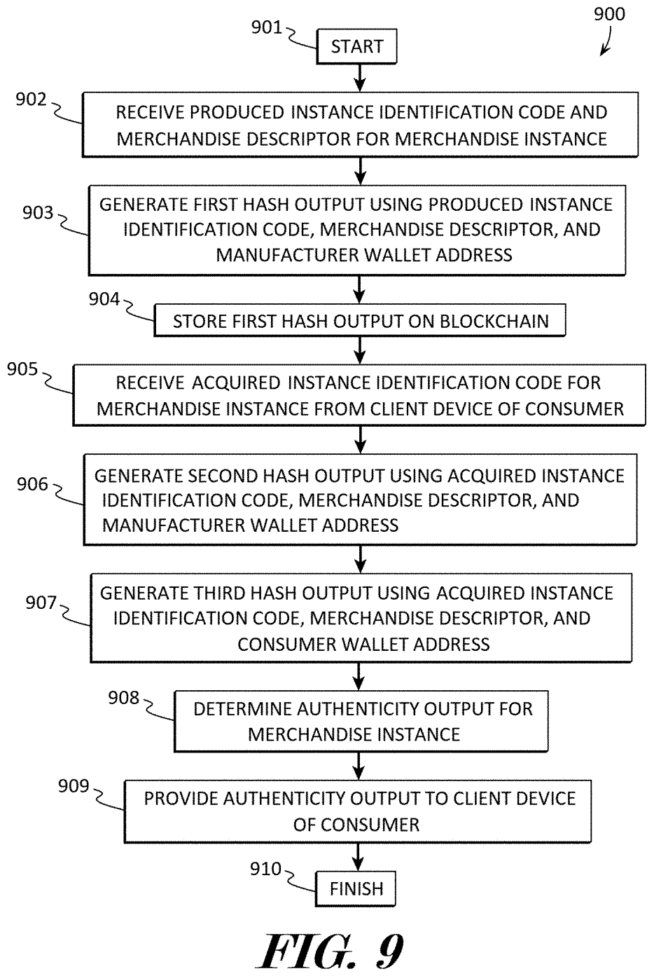

FIG. 9 illustrates a block diagram of an example of a computer-implemented method for verifying merchandise authenticity (“the method”) 900 according to various embodiments described herein. In some embodiments, the method 900 may be used to enable one or more producers 101B and consumers 101A to verify the authenticity of one or more merchandise instances 107 that may be purchased by consumers 101A using a public and/or private blockchain 113. One or more steps of the method 900 may be performed by a consumer application 141, producer application 142, system application 143, and/or blockchain application 144 which may be executed by a computing device processor, such as a processor 302 (FIG. 2) and/or a processor 402 (FIG. 3).

In some embodiments, the method 900 may start 901 and an instance identification code (produced instance identification code 160) and a merchandise descriptor for a merchandise instance 107 may be received by the system in step 902. In preferred embodiments, a producer 101B may enter a produced instance identification code 161 and a merchandise descriptor for one or more merchandise instances 107 via a producer application 142 running on their producer client device 400B, and the produced instance identification code 161 and a merchandise descriptor may be saved in a system database 120 in a merchandise instance 122 data record as an instance identification code 123 and merchandise descriptor 124, respectively, with each instance identification code 123 encoded in a single merchandise tag 108 of a single merchandise instance 107.

A blockchain application 144 of the system 100 may generate a manufacturer wallet address 125 and a consumer wallet address 126 for one or more merchandise instance 122 data records. In some embodiments, a manufacturer wallet address 125 and/or a consumer wallet address 126 may be made for each merchandise instance 107, for one or more merchandise instances 107, or even per producer 101B. In some embodiments, a manufacturer wallet address 125 and/or a consumer wallet address 126 may be embedded as part of the scannable code of a merchandise tag 108 of a merchandise instance 107. In further embodiments, a manufacturer wallet address 125 and/or a consumer wallet address 126 may be uploaded automatically to the producer 142 and consumer 141 apps (such as from a system application 143 running on a system server 300A). In further embodiments, a manufacturer wallet address 125 and/or a consumer wallet address 126 may be kept in the backend or system servers 300A (such as in a system database 120). The reason each merchandise instance 107 may be associated with a manufacturer wallet address 125 and a consumer wallet address 126 may include: to add certain security to the process (without them, it is impossible to register and verify info to/from the blockchain 113); it can distinguish for whatever reason, the same instance identification code is registered by different users 101; and the system 100 may restrict the authentication only to those who actual have the cryptocurrency wallet of the address, if needed.

In step 903, a first hash output 127 may be generated using the produced instance identification code 123, the merchandise descriptor 124, and a manufacturer wallet address 125. Optionally, the first hash output 127 may be stored a system database 120. Preferably, the first hash output 127 may be generated using a hash function that provides at least a 128 bit output, such as a SHA-256 hash function.

In step 904, the first hash output 127 may be stored on a blockchain database 113. In some embodiments, a first hash output 127 may be written to the blockchain 113 by creating or sending a cryptocurrency transaction on the blockchain database 113 that includes the first hash output 127. This transaction, containing the first hash output 127 and manufacturer wallet address 125 information, is propagated to the blockchain network 111 and the information is thus registered with the blockchain database 113. This process of registering data in blockchain database 113 may also be done with through a corresponding cryptocurrency wallet 115 which is often available for cryptocurrency, should the wallet 115 have the basic functions of registering data with the blockchain database 113 (an example of such cryptocurrency is DeepOnion). Optionally, the blockchain registering and verifying features may be performed via blockchain application 144 running on a producer client device 400B and/or running on a system server 300A.

In step 905, the instance identification code for the merchandise instance 107 may be received (acquired instance identification code 161) from a client device 400A of a consumer 101A. In preferred embodiments, the instance identification code 161 of the merchandise instance 107 may be acquired or provided to the system 100, preferably by scanning a merchandise tag 108 of the merchandise instance 107 into a consumer application 141 running on the consumer client device 400A of the consumer 101A that purchased the merchandise instance 107. Preferably, the instance identification code of a merchandise tag 108 may readable by an I/O interface of the consumer client device when the consumer client device is proximate to the merchandise instance 107. In further embodiments, the instance identification code of a merchandise tag 108 may readable by a camera 404B of the consumer client device 400A to provide an acquired instance identification code 161 to the system 100. In further embodiments, the instance identification code of a merchandise tag 108 may readable by a radio 406 of the consumer client device 400A to provide an acquired instance identification code 161 to the system 100.

A merchandise tag 108 may comprise a barcode, Quick Response (QR) code, Near-field communication (NFC) tag, Radio Frequency Identification (RFID) tag, etc., that may encode an instance identification code unique to a merchandise instance 107. In some embodiments, a merchandise tag 108 may comprise or encode a merchandise descriptor 124, manufacturer wallet address 125, and/or consumer wallet address 126 for the merchandise instance 107 so that the merchandise descriptor 124, manufacturer wallet address 125, and/or consumer wallet address 126 may be readable by an I/O interface 404 of the consumer client device 400A by scanning the merchandise tag 108.

Each merchandise instance 107 manufactured by a producer 101B may have a merchandise tag 108 attached to it, attached to its packaging, or otherwise coupled together. In preferred embodiments, each registered merchandise instance 107 may comprise a seal which may prevent access to the merchandise tag 108 and its instance identification code of a respective merchandise instance 107. For example, a registered merchandise instance 107 may comprise a shrink wrap or bubble packaging seal which may prevent the reading of the instance identification code of its merchandise tag 108 by a consumer client device 400A until the seal is broken.

In step 906, a second hash output 128 may be generated via a blockchain application 144 using the acquired instance identification code 161, the merchandise descriptor 124, and the manufacturer wallet address 125. In some embodiments, the merchandise descriptor 124 and/or the manufacturer wallet address 125 may be readable by an I/O interface 404 of the consumer client device 400A by scanning the merchandise tag 108. In further embodiments, the merchandise descriptor 124 and/or the manufacturer wallet address 125 associated with the instance identification code 123 may be retrieved from a system database 120. In some embodiments, a second hash output 128 may be generated via a blockchain application 144 running on the consumer client device 400A. In further embodiments, a second hash output 128 may be generated via a blockchain application 144 running on a system server 300A. Preferably, the second hash output 128 may be generated using a hash function that provides at least a 128 bit output, such as a SHA-256 hash function.

In step 907, a third hash output 129 may be generated via a blockchain application 144 for the merchandise instance 107 using the acquired instance identification code 161, the merchandise descriptor 124, and a consumer wallet address 126. In some embodiments, a third hash output 129 may be generated via a blockchain application 144 running on the consumer client device 400A. In further embodiments, a third hash output 129 may be generated via a blockchain application 144 running on a system server 300A. Preferably, the third hash output 129 may be generated using a hash function that provides at least a 128 bit output, such as a SHA-256 hash function. In some embodiments, the third hash 129 may be stored on the blockchain 113 by sending a cryptocurrency transaction to the blockchain 113 which may include or generate one or more time stamps associated with the third hash 129, and a time stamp may be used to produce analytic data describing a sale progression of the merchandise instance 107.

In step 908, an authenticity output 130 for the merchandise instance 107 may be generated by a consumer application 141 and/or a system application 143. The authenticity output 130 may be generated using the first hash output 127, second hash output 128, and third hash output 129.

In some embodiments, the authenticity output 130 may describe the merchandise instance 107 as being counterfeit if the first hash output 127 and second hash output 128 do not match each other.

In some embodiments, the authenticity output 130 may describe the merchandise instance 107 as being authentic if the first hash output 127 and second hash output match 128 and if the third hash output 129 is not already stored on the blockchain 113. In further embodiments, the authenticity output 130 may describe the consumer 101A that scanned the merchandise tag 108 of the product instance 107 as being the first owner of the merchandise instance 107 if the third hash output 129 is not already stored on the blockchain 113. In further embodiments, the third hash 129 may be stored on the blockchain 113 if the first hash output 127 and second hash output 128 match and if the third hash output 129 is not already stored on the blockchain 113. In further embodiments, a time stamp, such as which may describe the time and date that the third hash 129 was generated, which may describe the time and date that the third hash 129 was stored in the blockchain 113, etc., may associated with the third hash output 129, and the time stamp is used to produce analytic data describing a sale progression of the merchandise instance 107.

In some embodiments, the authenticity output 130 may describe the merchandise instance 107 as being counterfeit or being second hand authentic if the first hash output 127 and second hash output match 128 and if the third hash output 129 is stored on the blockchain 113.

In step 909, the authenticity output 130 may be provided to the client device 400A of the consumer 101A via a consumer application 141, such as by being displayed on a display screen 404A of the consumer client device 400A. After step 909, the method 900 may finish 910.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine-readable storage device, a machine-readable storage substrate, a memory device, a composition of matter effecting a machine-readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors (computing device processors) executing one or more computer applications or programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), light emitting diode (LED) display, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random-access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD), light emitting diode (LED) display, or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g., through a wireless cellular network or WIFI network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device or client device such as a personal digital assistant (PDA), laptop computer, tablet computer, smartphone, or cellular telephone. The LAN communications network and the other communications networks such as cellular wireless and Wi-Fi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A method for verifying merchandise authenticity, the method comprising the steps of:
receiving a produced instance identification code and a merchandise descriptor for a merchandise instance;
generating a first hash output using the produced instance identification code, the merchandise descriptor, and a manufacturer wallet address;
storing the first hash output on a blockchain;
receiving an acquired instance identification code for the merchandise instance from a client device of a consumer;
generating a second hash output using the acquired instance identification code, the merchandise descriptor, and the manufacturer wallet address;
generating a third hash output using the acquired instance identification code, the merchandise descriptor, and a consumer wallet address;
determining an authenticity output for the merchandise instance; and
providing the authenticity output to the client device of the consumer.

2. The method of claim 1, wherein the first hash is stored on the blockchain by sending a cryptocurrency transaction to the blockchain.

3. The method of claim 1, wherein the third hash is stored on the blockchain by sending a cryptocurrency transaction to the blockchain.

4. The method of claim 1, wherein the authenticity output describes the merchandise instance as being counterfeit if the first hash output and second hash output do not match.

5. The method of claim 1, wherein the authenticity output describes the merchandise instance as being authentic if the first hash output and second hash output match and if the third hash output is not already stored on the blockchain.

6. The method of claim 5, wherein the authenticity output describes the consumer as being the first owner of the merchandise instance if the third hash output is not already stored on the blockchain.

7. The method of claim 5, wherein the third hash output is stored on the blockchain if the first hash output and second hash output match and if the third hash output is not already stored on the blockchain.

8. The method of claim 7, wherein a time stamp is associated with the third hash output, and wherein the time stamp is used to produce analytic data describing a sale progression of the merchandise instance.

9. The method of claim 1, wherein the authenticity output describes the merchandise instance as one of being counterfeit and being second hand authentic if the first hash output and second hash output match and if the third hash output is stored on the blockchain.

10. The method of claim 1, wherein the first, second, and third hash outputs are generated using a SHA-256 hash function.

11. The method of claim 1, wherein the first, second, and third hash outputs are generated using a hash function that provides at least a 128 bit output.

12. The method of claim 1, wherein the blockchain is a public blockchain.

13. The method of claim 1, wherein the blockchain is a private blockchain.

14. The method of claim 1, wherein the acquired instance identification code is readable by an I/O interface of the consumer client device when the consumer client device is proximate to the merchandise instance.

15. The method of claim 14, wherein the merchandise instance comprises a seal, and wherein the acquired instance identification code is not readable by an I/O interface of the consumer client device until the seal is broken.

16. The method of claim 14, wherein the acquired instance identification code is readable by a camera of the consumer client device.

17. The method of claim 14, wherein the acquired instance identification code is readable by a radio of the consumer client device.

18. The method of claim 1, wherein the merchandise descriptor is readable by an I/O interface of the consumer client device when the consumer client device is proximate to the merchandise instance.

19. The method of claim 1, wherein the consumer wallet address is readable by an I/O interface of the consumer client device when the consumer client device is proximate to the merchandise instance.

20. The method of claim 1, wherein the manufacturer wallet address is readable by an I/O interface of the consumer client device when the consumer client device is proximate to the merchandise instance.
